(19) United States
(12) Patent Application Publication
(10) Pub. No.: US 2015/0284192 A1
(43) Pub. Date: Oct. 8, 2015

(54) DEVICE AND METHOD FOR STACKING AND DE-STACKING GOODS CARRIERS

(71) Applicant: SEMOCONSULT GMBH, Bobingen (DE)

(72) Inventors: Herwig Hirschek, Bobingen (DE); Patrick Hirschek, Augsburg (DE)

(21) Appl. No.: 14/440,480

(22) PCT Filed: Nov. 5, 2013
(86) PCT No.: PCT/EP2013/073052

§ 371 Date: May 4, 2015

(30) Foreign Application Priority Data
Nov. 6, 2012 (DE) 20 2012 104 254.1

(51) Int. Cl. B65G 57/30; B65G 25/04

(52) U.S. Cl. CPC B65G 57/301; B65G 25/04; B65G 2814/0304

(57) ABSTRACT

The invention relates to a re-stacking device (1) and a re-stacking method for goods carriers (6). The re-stacking device (1) has a plurality of stacking devices (4, 5) arranged side-by-side at a distance from one another, each having at least one goods carrier stack and a process zone (12) arranged therebetween. The stacking devices (4, 5) and the process zone (12) are connected by a transport device (6) to a plurality of transport means (7, 8) for goods carriers (2). The transport means (7, 8) are movable relative to one another with overlapping motion paths and have carrying means (29, 30) which are designed for transporting and mutually transferring a goods carrier (2) between the transport means (7, 8). Loading and unloading of the goods carriers (2) or another process involving the goods (3) can take place in the process zone (12).

The present invention pertains to a stacking and de-stacking device with the features in the preamble of the principal claim.

Such a stacking and de-stacking device is known from DE 37 33 622 A1. It is intended for the intermediate storage of empty and loaded goods carriers or pallets and has two tower-like stacking devices and a loading device between them for loading and unloading the goods carriers with goods arranged individually or in groups. A conveying device with a single rail-borne transfer car thereby connects the stacking devices and the loading device.

DE 33 45 920 A1 shows a similar stacking and de-stacking device with a modified conveying device, which has a stationary roller conveyor for the pallets with a pallet-towing car arranged under it.

Further, a stacking and de-stacking device with an individual belt conveyor for workpiece holders, which connects the stacking devices and the loading device, is known from practice.

The object of the present invention is to show an improved stacking and de-stacking method, and in particular an improved stacking and de-stacking device.

The present invention accomplishes this object with the features in the principal claim.

The claimed stacking and de-stacking method for goods carriers has the advantage of a higher flexibility and efficiency compared to prior-art stacking and de-stacking devices. In addition, a more compact construction is possible. Further, the stacking and de-stacking device makes it possible to move a goods carrier in a synchronized manner when interacting with a processing device, and especially when loading and unloading with goods, so that the loading processes actuated by the loading device may run in a particularly reliable manner and always have similar short paths. In this case, a transfer of goods, which are arranged in groups, e.g., in one or more rows, by means of a loading device on the fly is also possible.

Further, it is advantageous that the access to the stored goods carriers and also to the goods located there may be arbitrary. In particular, the stacking and de-stacking device can be used with a plant expansion for the implementation of a true first in-first out principle.

The claimed arrangement of conveying means, which are movable in relation to one another, with carrying means designed for conveying and for mutual transfer for goods carriers is particularly favorable for achieving a high efficiency and rapidity in the handling process, especially the loading and unloading process as well as loading in and unloading from the stacking devices. A conveying means can provide a goods carrier at the processing device and also move in relation to same in a continuous or synchronized manner, whereby another and especially second conveying means can transfer or take over another goods carrier at a stacking device for putting in storage or taking out of storage. This may be an empty or loaded goods carrier.

Further, the processing device may operate free from interruption, whereby a new goods carrier can be provided immediately after the end of the process by means of the conveying means, which are movable independently and independently of one another. Process breaks and mutual distances of goods carriers, as in the state of the art, can be avoided. The possibility of transferring a goods carrier from one to another conveying means is also advantageous for interruption-free operation.

For achieving the above-mentioned effects, the conveying means have a suitable design, whereby the preferred embodiment as a transfer car with carrying means, which are capable of overlapping one another and are controllable, offers particular advantages with respect to design effort, space requirement and control possibilities.

The rapid transfer or takeover of a goods carrier between a conveying means and a stacking device is favored by the arrangement of a support device for the stack of goods carriers and a separating and transferring device. As a result of this, the times for the separating and providing of a goods carrier at the stacking device and for the movement of the conveying means along a path of motion can be overlapped with one another. Thus, especially short times for changing the goods carrier and for providing a new goods carrier at the processing device can be achieved. This makes possible an especially fast and efficient processing device and is also beneficial to a possibility of increasing the efficiency of an entire plant, into which a stacking and de-stacking device is integrated and is used, e.g., for the intermediate storage of goods carriers and goods.

The claimed stacking and de-stacking method is suitable for any kinds of goods. There are particular advantages for individually packaged products, e.g., packets, cans or other containers. The goods carriers may have a suitable and adapted design for this.

Further advantageous embodiments of the present invention are given in the subclaims.

The present invention is shown in examples and schematically in the drawings. In particular,

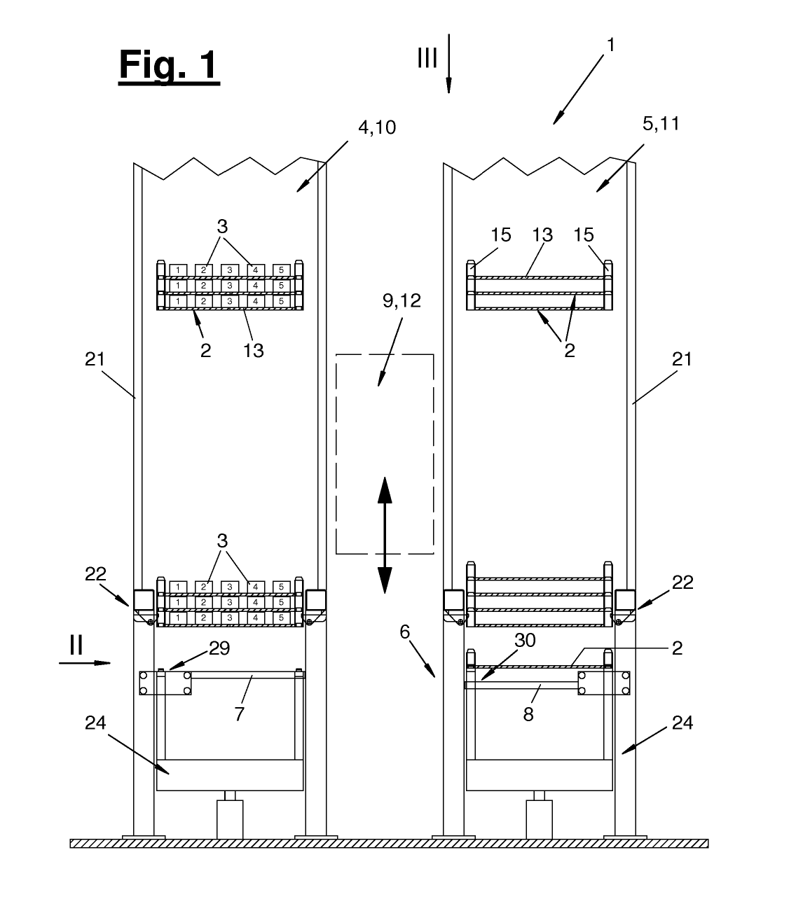

FIG. 1 shows a stacking and de-stacking device for goods carriers with two stacking devices, a processing device and a connecting conveying device for goods carriers,

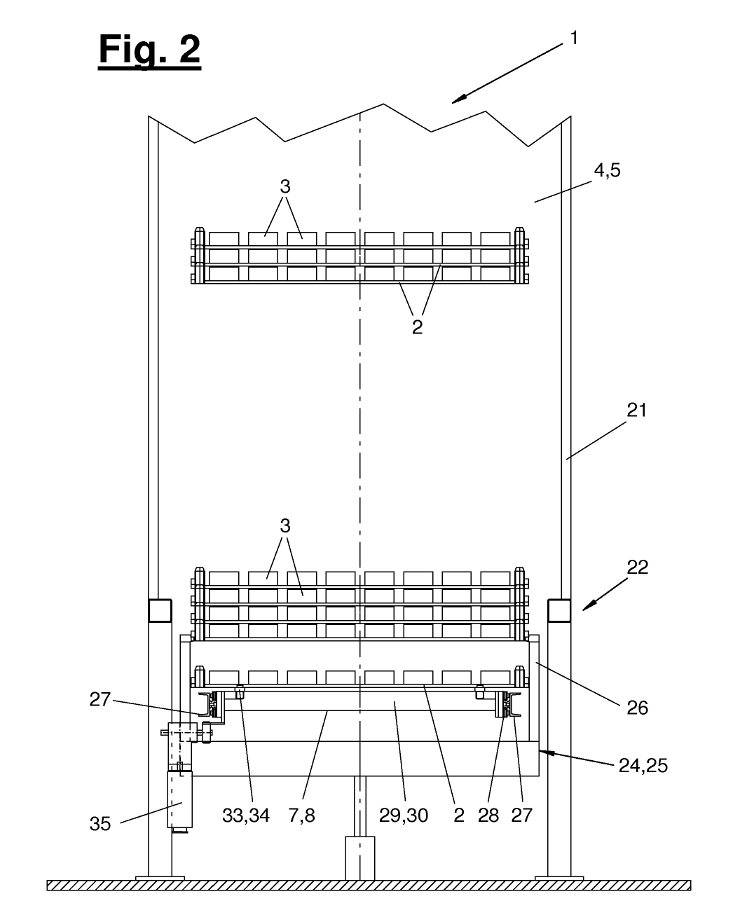

FIG. 2 shows a side view of a stacking device with a conveying means of a conveying device in a side view according to arrow II of FIG. 1,

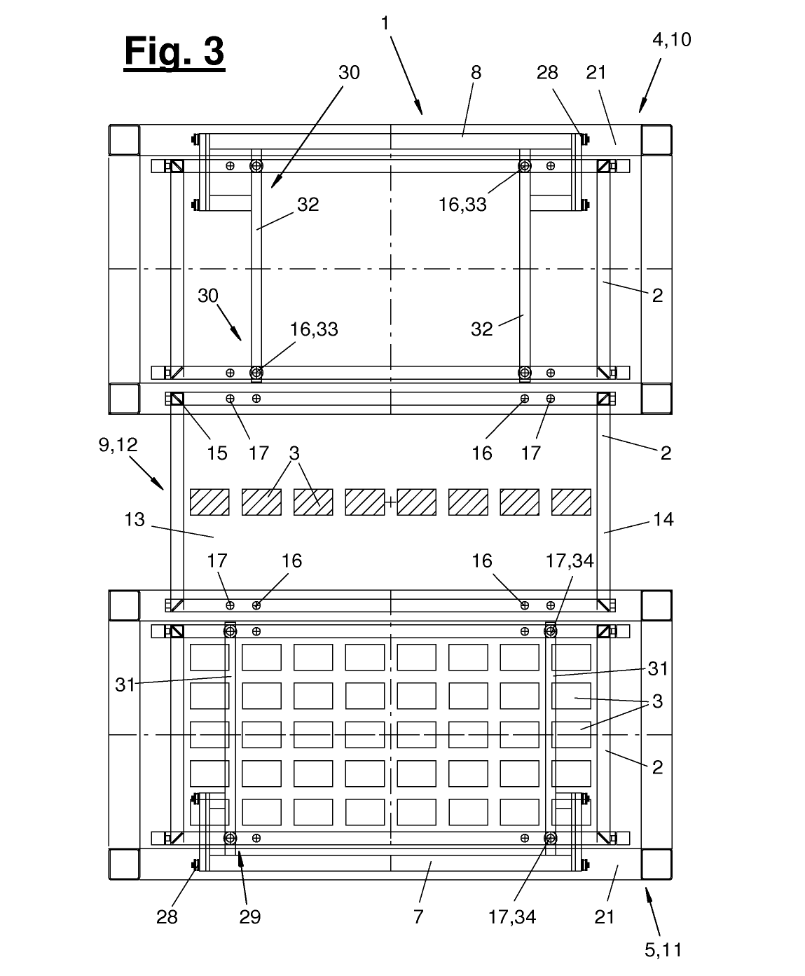

FIG. 3 shows a top view of the stacking and de-stacking device according to arrow III of FIG. 1,

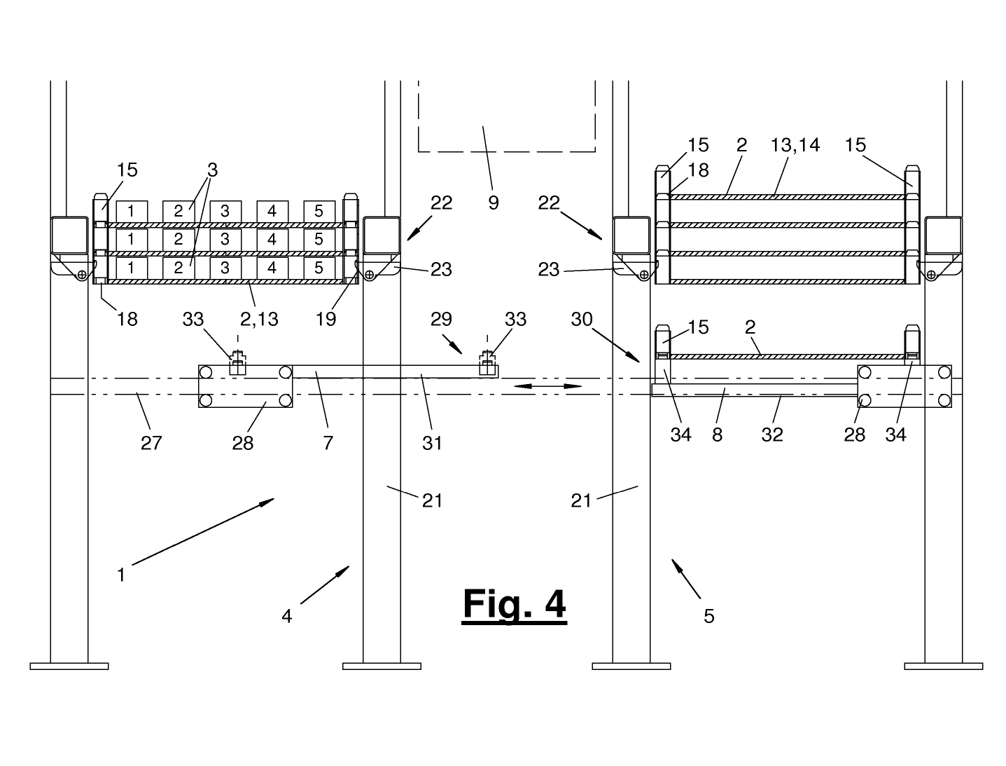

FIG. 4 shows an enlarged detail view of the conveying device and of part of the stacking devices according to FIG. 1,

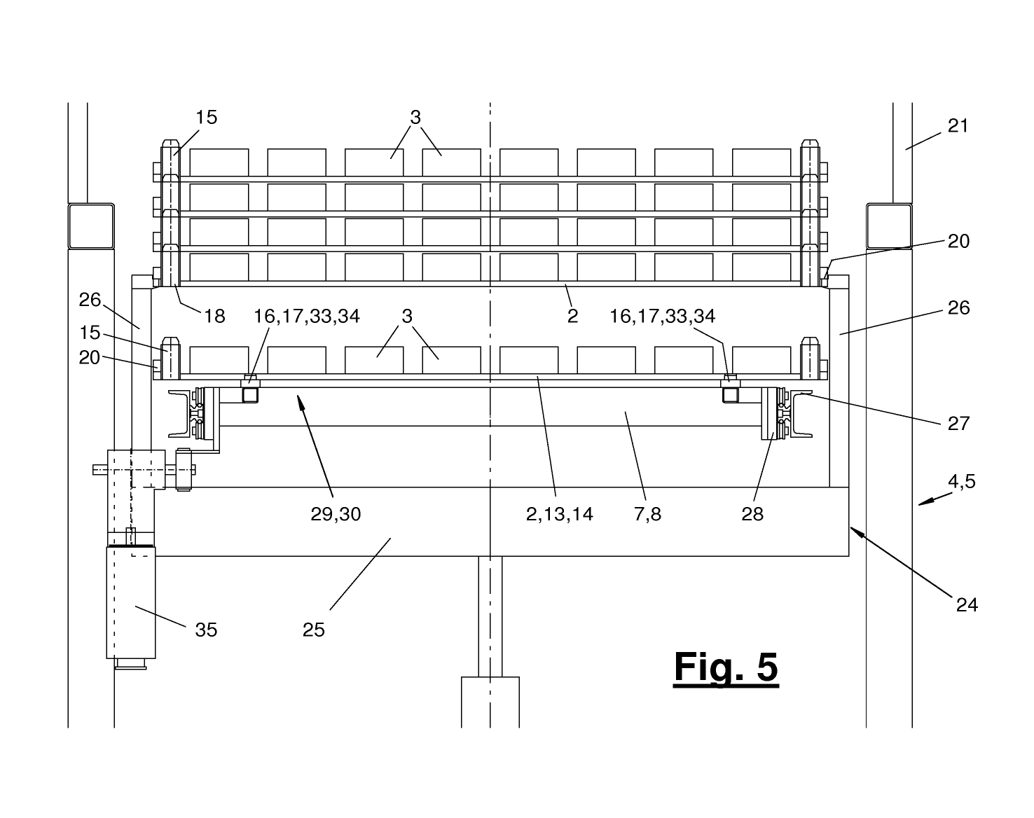

FIG. 5 shows an enlarged detail view of FIG. 2,

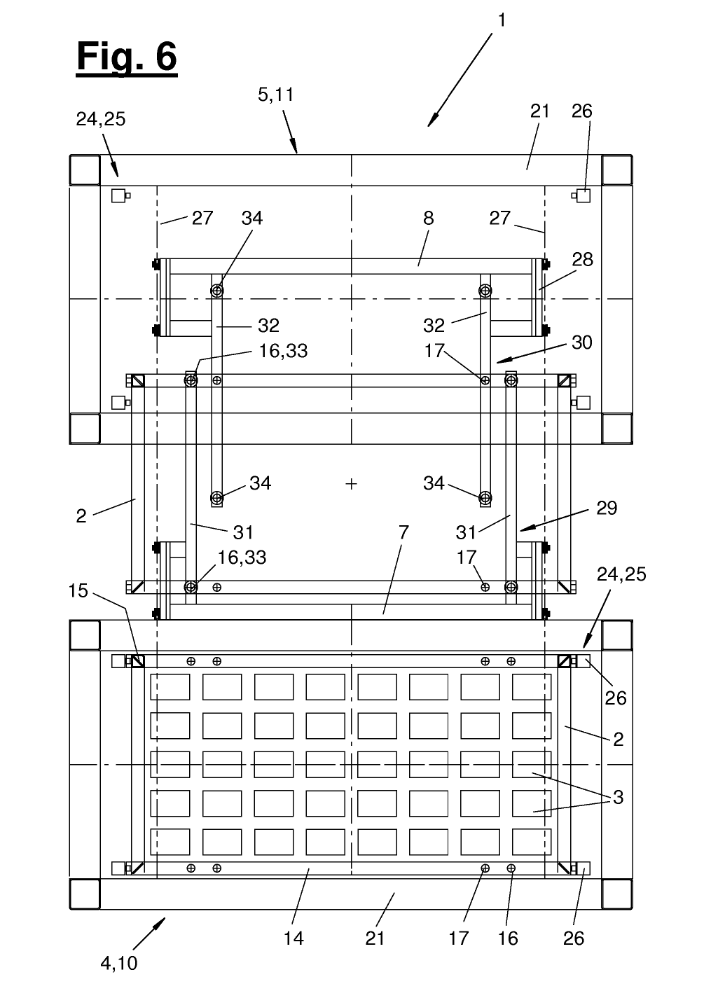

FIG. 6 shows a top view according to FIG. 3 with two conveying means in an overlapping position, and

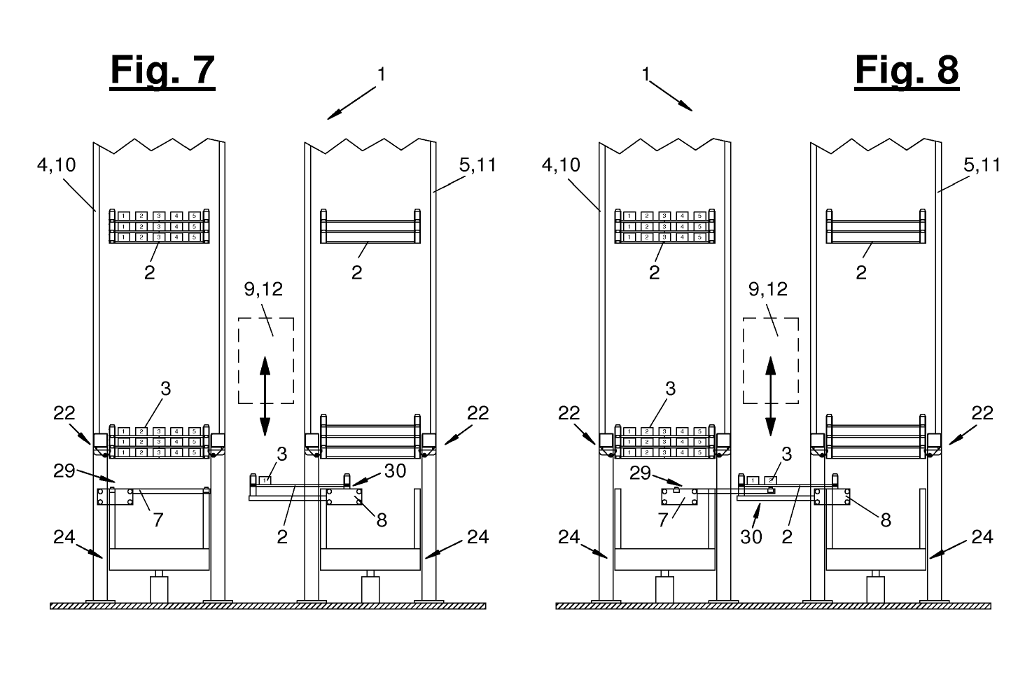

FIGS. 7 through 17 show an operation process of the stacking and de-stacking device in a plurality of [sic, “mehren” is an obvious typo for “mehreren”—Tr.Ed.] steps.

The present invention pertains to a stacking and de-stacking device (1) and a method for stacking and de-stacking goods carriers (2).

The goods carriers (2), which are also designated as trays, are each used for receiving at least one, preferably a plurality of goods (3). The goods (3) may be of any kind and design. Preferably, they are individually packaged products. They may be, e.g., packets, cans, bottles or other containers.

The stacking and de-stacking device (1) is used for receiving and storing a plurality of empty or loaded goods carriers (2) in two or more stacks of carriers. The goods carriers (2) may have a stackable design for this and have a carrier bottom (13) for receiving a plurality of goods (3), which, e.g., may be arranged in one or more rows thereon. The carrier bottom (13) may have a closed plate-like design. As an alternative, it may have a design adapted to the goods (3) with recesses, a frame or other suitable mounting or guiding means for the goods (3).

The carrier bottom (13) may be arranged on a support frame (14), which have [sic, “aufweisen” should be “aufweist”—has—Tr.Ed.] one or more support columns (15) at suitable points for the mutual support and guiding of the goods carriers (2) in the stack. The support columns (15) may be arranged, e.g., at the corners of a prismatic, especially rectangular carrier bottom (13) and designed as upright support posts. The support columns (15) may project upwards over the goods (3). They may, further, have a nestable and mutual guiding design. For this, they have, e.g., a conical tip on the top side and a matching mounting or supporting point (18) on the bottom side, e.g., a conical receiving opening. The goods carriers (2) in the stack of carriers can be supported and mutually guided via this.

As an alternative, other, e.g., strip-like designs of the support columns (15) are also possible. The support columns may extend from the carrier bottom (13) downwards or downwards and upwards as well. Further, they may extend only over a partial height of the goods (3). This makes possible a sensory detection of the upper areas of all goods (3) located on the goods carrier (2) for a check of the position.

The stacking and de-stacking device (1) has a plurality of stacking devices (4, 5) or stacking zones (10, 11) each for receiving and handling at least one stack of goods carriers. Further, the stacking and de-stacking device (1) has at least one processing zone (12) and a processing device (9) there for the carrying out of one or more processes at or with the goods (3). Moreover, the stacking and de-stacking device (1) includes a conveying device (6) for goods carriers (2), which connects the stacking devices (4, 5) and the one or more processing devices (9) with one another and makes possible the conveying of carriers between these devices (4, 5, 9).

Two stacking devices (4, 5), which are arranged at a lateral distance next to one another, are present in the preferred embodiment shown in FIG. 1, whereby a processing device (9) is arranged in the free space (12) between them. Each of the stacking devices (4, 5) has a tower-like shape with a frame (21) and a support device (22) for a stack of carriers. Further, they have each a separating and transferring device (24) for an external, and especially lower, goods carrier (2) in the stack of carriers. The one stacking device (5) receives, e.g., loaded goods carriers (2) and the other stacking device (4) receives empty goods carriers (2).

The processing device (9) is designed as a loading device in the exemplary embodiment shown, which reloads goods (3) individually or preferably in groups from a conveyor, e.g., a belt conveyor, to a goods carrier (2) provided by the conveying device (6). The goods carrier (2) is thereby loaded with goods (3) in a preferably preset group arrangement, especially a row arrangement. The loading process may also run in reverse, whereby goods (3) are reloaded from a goods carrier (2) onto the said conveyor. During the loading process, the goods carrier (2) may be moved in a synchronized manner. During the loading process with transfer in rows, the loading device can thereby always perform the same movement. This facilitates control and leads to short paths, high speeds and very short cycle times.

The one or more goods (3) can be conveyed continuously on the conveyor, whereby the loading device (9) may have a robot with a gripping device which can be displaced for a period of time in a synchronized manner to the conveying movement, which makes possible a loading and unloading on the fly. Structural details of the exemplary embodiment are not shown for the sake of clarity.

As an alternative or in addition, the processing device (9) may have a different design. It may process or handle, e.g., the goods located on a goods carrier (2). This may be, e.g., a printing, a resorting or the like. The processing device (9) may also comprise a plurality of such individual devices. Further, the processing device (9) may be arranged at another site and with a different spatial assignment to the stacking devices (4, 5).

The conveying device (6) extends over the above-mentioned devices (4, 5, 9) and connects these with one another. It thereby extends into the stacking devices (4, 5) and is arranged, e.g., below the processing device (9). In the exemplary embodiment shown, the conveying device is arranged on the bottom side of the stacking and de-stacking device (1). As an alternative, it may be arranged at another site, especially on the top side and thereby possibly also above a processing device (9).

The conveying device (6) has a plurality of conveying means (7, 8) with carrying means (29, 30), whereby the conveying means (7, 8) are arranged and driven in a movable manner and movable in relation to one another. The carrying means (29, 30) are used for the conveying and mutual transfer of a goods carrier (2) and have a suitable design for this.

The conveying means (7, 8) are independently movable and have an independently controllable drive (35) each. The conveying means (7, 8) are moved along a preferably straight path of motion, which can be defined by a suitable guide (27), e.g., a track guide. The conveying means (7, 8) may be moved in the same direction of movement behind one another or towards one another or away from one another in the opposite direction. They are preferably arranged displaceably and supported at the guide (27). The conveying means (7, 8) can be moved in a continuous and/or synchronized manner. They may especially have paths of motion overlapping one another, whereby they are moved towards one another and thereby mesh with one another and overlap one another at least with their carrying means (29, 30).

The conveying means (7, 8) have each a path of motion or guide (27) extending over the stacking devices (4, 5) and the processing device (9). They may have a common guide (27) or separate guides in this case. Preferably, the path of motion and the guide (27) are aligned horizontally.

The conveying means (7, 8) are preferably designed as transfer cars, which have a frame with a chassis (28) and the respective carrying means (29, 30) and roll or slide along the guide (27). The carrying means (29, 30) are designed differently and are arranged in order to be able to mesh with one another and overlap one another during a moving together of the conveying means or transfer cars (7, 8). Hereby, the carrying means (29, 30) have each also a movable and controllable design, which makes possible for them a transfer of a goods carrier (2) from one conveying means (7, 8) to another in the overlapping position. On the other hand, a takeover or discharge of a goods carrier (2) at a stacking device (4, 5) may also possibly be achieved hereby.

The carrying means (29, 30) may have a suitable adjustability for the transfer, whereby they perform, e.g., a vertical lifting and lowering motion. It may also be sufficient when only one carrying means (29, 30) has such an adjustability, especially vertical adjustability. There are a plurality of variant possibilities [sic, “Variantionsmöglichkeiten” is an obvious typo for “Variantsmöglichkeiten”—Tr.Ed.] for the structural design.

In the embodiment of FIGS. 1 through 17 shown, both conveying means (7, 8) operate the processing device (9) and may position a goods carrier (2) here or move it past. In addition, the one conveying means (7) operates the stacking device (4) on the left side in FIG. 1 and the other conveying means (8) operates the stacking device (5) on the right side. For a conveying of a goods carrier (2) from one stacking device (4, 5) to another, a transfer of carriers between the conveying means (7, 8) takes place at a suitable site, especially in the area of the processing device (9).

In a modified embodiment, the conveying means (7, 8) may move and operate both stacking devices (4, 5) or stacking zones (10, 11) as well. This makes possible, e.g., in the event of the failure of one conveying means (7, 8) a continuation of the conveying operation with reduced efficiency by means of the other conveying means (7, 8).

As FIGS. 3 and 6 illustrate in the top view, each of the carrying means (29, 30) has one or more, preferably two each, supporting arms (31, 32) with carrying elements (33, 34), which are able to receive and possibly discharge a goods carrier (2) in a defined position. The supporting arms (31, 32) are aligned in the direction of movement or along the path of motion or guide (27). Hereby, the conveying means (7, 8) or their carrying means (29, 30) have supporting arms (31, 32), which are arranged differently and directed towards one another and which may overlap one another when the conveying means (7, 8) are brought closer to one another. The supporting arms (31) have, e.g., a greater distance than the supporting arms (32) and may enclose same in the overlapping position on the outside. Moreover, the supporting arms (31, 32) may be arranged in different vertical positions, as FIG. 1 and the enlarged detail view of FIG. 4 show this in a side view.

The carrying elements [sic, “Trageelemente” is a typo for “Tragelemente”—Tr.Ed.] (33, 34) may interact and here preferably contact in a positive-locking manner or mesh with correspondingly arranged mounts (16, 17) at the goods carrier (2). The carrying elements (33, 34) are correspondingly movable, preferably vertically adjustable for this.

The vertical adjustment of the carrying means (29, 30) can be achieved in a variety of ways. In the variant shown, the carrying elements (33, 34) are designed as extendable supporting pins, which are arranged in a liftable and lowerable manner at the supporting arms (31, 32) and have corresponding controllable lifting drives. In another variant, which is not shown, the supporting arms (31, 32) may be vertically adjustable to the other frame parts or to the chassis (28). It is also possible to vertically adjust a conveying means (7, 8) or its guide (27).

According to FIGS. 3 and 6, each carrying means (29, 30) has four carrying elements (33, 34) arranged in a rectangle, whereby each goods carrier (2) has correspondingly arranged mounts (16, 17). These [mounts] are designed, e.g., as insertion openings on the bottom side of the goods carrier (2), especially on the longitudinal sides of the support frame (14).

Corresponding to the supporting arms (31, 32), the carrying elements (33, 34) and the associated mounts (16, 17) also have a mutually offset arrangement, so that an overlapping position is possible and in the overlapping position, all carrying elements (33, 34) can also together come into contact with the mounts (16, 17) and with a goods carrier (2). The goods carrier (2) can be transferred from one carrying means (29) to the other carrying means (30) by means of the independently controlled movability of the carrying elements (33, 34) and their lifting drives.

The carrying elements [sic, “Trageelemente” is a typo for “Tragelemente”—Tr.Ed.] (33, 34) may be adapted to the possibly different vertical positions of the supporting arms (31, 32) and have a different length. In the embodiments shown, the carrying elements (3, 34) are each designed as extendable supporting pins with a conical tip, whereby the mounts (16, 17) are designed as matching cone openings.

As FIGS. 3 and 6 illustrate, the mounts (16, 17) are arranged at a distance from the corner areas and the support posts (15) there of the goods carriers of the goods carriers [sic, “der Warenträger” repeated—Tr.Ed.] (2). This makes possible a contact of the support device (22) and the separating and transferring device (24) at a different site and parallel to the carrying means (29, 30). A transfer and takeover of goods carriers (2) at the stacking devices (4, 5) can be achieved hereby. In addition, a transfer of the goods carriers (2) between a support device (22) and a separating and transferring device (24) can take place within the stacking devices (4, 5).

As FIG. 1 shows in overall view and FIG. 4 shows in an enlarged detail view, the support device (22) arranged at the frame (21) has stack holders (23) which mesh in a positive-locking manner with the lowest goods carrier (2) in the stack of carriers and hold and support as well as possibly position this goods carrier (2) together with the stack of carriers resting thereon. The stack holders (23) may be designed, e.g., as support fingers pivotably mounted on the frame (22), which mesh with a suitable mount [sic, “Aufnahem” is an obvious typo for “Aufnahme”—Tr.Ed.] or support point (19) at the goods carrier (2). In the support position, they may be supported at the frame (22) and secure their rotary position. An opening and closing of the stack holders (23) is possible by means of the separating and transferring device (24), which cooperates with the support devices (22) for this purpose.

A goods carrier (2) may have a plurality of support points or mounts (19), which are arranged, e.g., at the corner areas and the support posts (15) there. The mounts (19) may be designed as lateral openings in the jacket of supports posts (15) which are cylindrical and hollow on the inside. The support device (22) has correspondingly four stack holders (23). The stack holders (23) may be actuated by a drive or via its own weight or the stack of carriers.

The separating and transferring device (24) is used for taking over and discharging individual goods carriers (2) from and to a conveying means (7, 8) as well as for removing and feeding individual goods carriers (2) to the stacking device (4, 5). The separating and transferring device (24) has for this a suitable structural design, which can be embodied in a variety of ways.

In the exemplary embodiments shown, the separating and transferring device (24) has a controllable lifting device (25), which has, e.g., a frame with a drive arranged under it, especially a cylinder, and lifting fingers (26) projecting upwards. The lifting fingers (26) come into contact with suitable points of the goods carrier (2), e.g., at the corner areas and at the support posts (15), whereby they are arranged in a corresponding number and distribution. The goods carrier (2) has for this purpose suitable mount[s] or support points (20), which are designed, e.g., as projections on the outside at the support posts (15). The upper ends of the lifting fingers (26) may have a centering design and, in addition, may have an extension, with which they actuate and detach the stack holders (23) in the meshing position, so that the stack of carriers then rests on the lifting fingers (26) and can be moved along during their lifting or lowering movement.

The separating and transferring device (24) may otherwise cooperate with the support device (22) in any other suitable manner and provide for a separation and takeover or feeding of the outermost or lowest goods carrier (2) in the stack of carriers. The above-mentioned actuation of the stack holders (23) takes place when the lifting device (25) meshes with the lowest goods carrier (2). As soon as the lifting device (25) sinks further and loses contact with the stack holders (23), these [holders] fall in again and hold onto the stack of carriers. The goods carrier (2) mounted at the lifting device (25) is thereby detached and separated from the stack of carriers. It can then be moved downwards a bit further into an intermediate position, in which a transfer to a conveying means (7, 8) and its carrying means (29, 30) is possible. The carrying means (29, 30) may grasp between the lifting fingers (26), whereby the transfer takes place by means of a vertical relative movement between the carrying elements (33, 34) and the lifting device (25).

In reverse kinematics, the lifting device can take over a goods carrier already held by a conveying means (7, 8) by means of an opposite vertical relative movement and lead with a further upwards movement to the stack of carriers held by the support device (22) and mesh with the mounts (18) there. By means of a continued lifting movement, the entire stack of carriers is raised, whereby the support device (22), e.g., acting on one side, is detached and again meshes with the newly fed lowest goods carrier (2) after reaching an end position.

FIGS. 2 and 5 show this interaction of the lifting device (25) with the stack of carriers, whereby the conveying means (7, 8) is already again moved out of the meshing area of the lifting device (25). The support device (22) is not shown in FIGS. 2 and 5 and is only suggested by an arrow. On the other hand, FIG. 4 shows only the support device (22), but not the lifting device (25). The above-described operations of the lifting device (25) and of the lifting fingers (26) also apply correspondingly to other structural embodiments of a separating and transferring device (24) or of a support device (22).

FIGS. 7 through 17 illustrate an operation process in a plurality of steps. The conveying means (8) on the right side in FIG. 1 has taken over an empty goods carrier (2) from the stacking device (5) and moved it into a position below the processing device (9), which then placed a first row of goods (3) on the goods carrier (2). The other conveying means (7) is located in a position, which is functionless at the moment, in the area of the other stacking device (4).

In the next step of FIG. 8, the conveying means (8) is moved in a synchronized manner a bit further to the left for receiving the next row of goods (3). The other conveying means (7) has in the meantime been moved in the opposite direction and towards the conveying means (8). Its carrying means (29) is deactivated or lowered and then moves under the goods carrier (2) which is held in a raised position at the activated other carrying means (30).

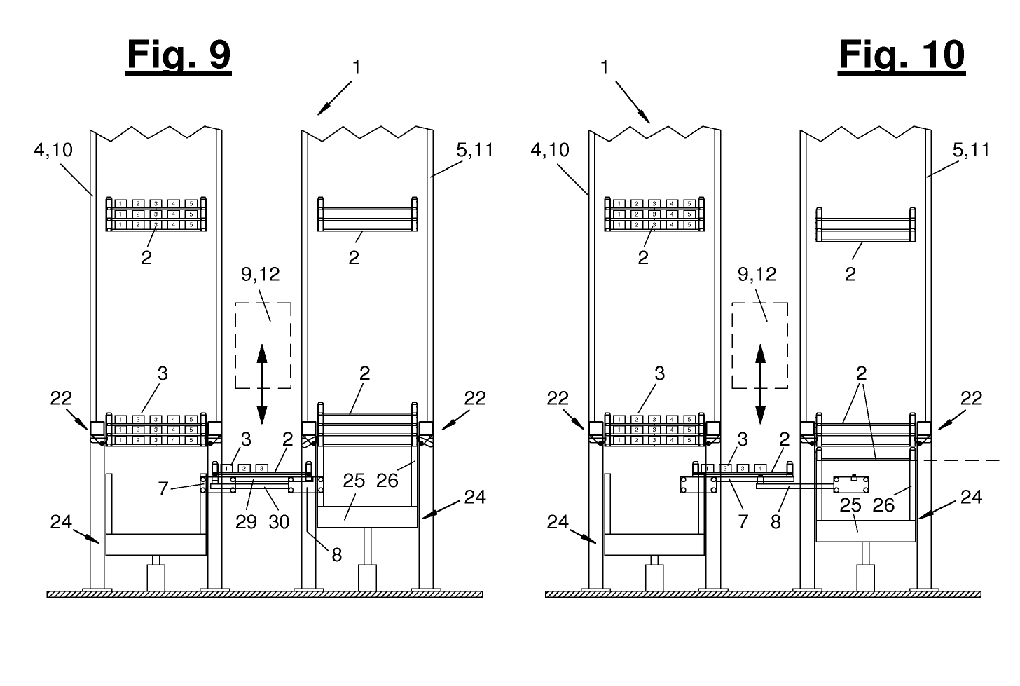

In the next position of FIG. 9, the conveying means (8) has been moved a further synchronized step to the left for receiving a third row of goods, whereby the two conveying means (7, 8) now assume a mutual overlapping position, in which the carrying means (29), which is still deactivated at the moment, is positioned in a position suitable for takeover below the goods carrier (2) still held by the conveying means (8).

From the overlapping position shown in FIG. 9, the carrying means (29) is then activated with the conveying means (7, 8), which is stationary at the moment, or moved in a synchronized manner, as an alternative, whereby its carrying elements (33) move out, mesh with the mounts (16) of the goods carrier (2) and support same. At the same time or subsequently, the carrying means (30) can be deactivated by lowering its carrying elements (34) and unmeshed from the goods carrier (2). The further movement of the goods carrier (2) suitable for the process towards the processing device (9) is then brought about by the conveying means (7), whereby, e.g., according to FIG. 10, the next row of goods is placed on. The conveying means (8), which is now detached from the goods carrier (2), can return empty to the stacking device (5). Here, according to FIG. 10, the separating and transferring device (24) has in the meantime received the lowest goods carrier (2) from the stack of carriers, separated it and conveyed it into an intermediate position, which is identified by a dashed diagonal line.

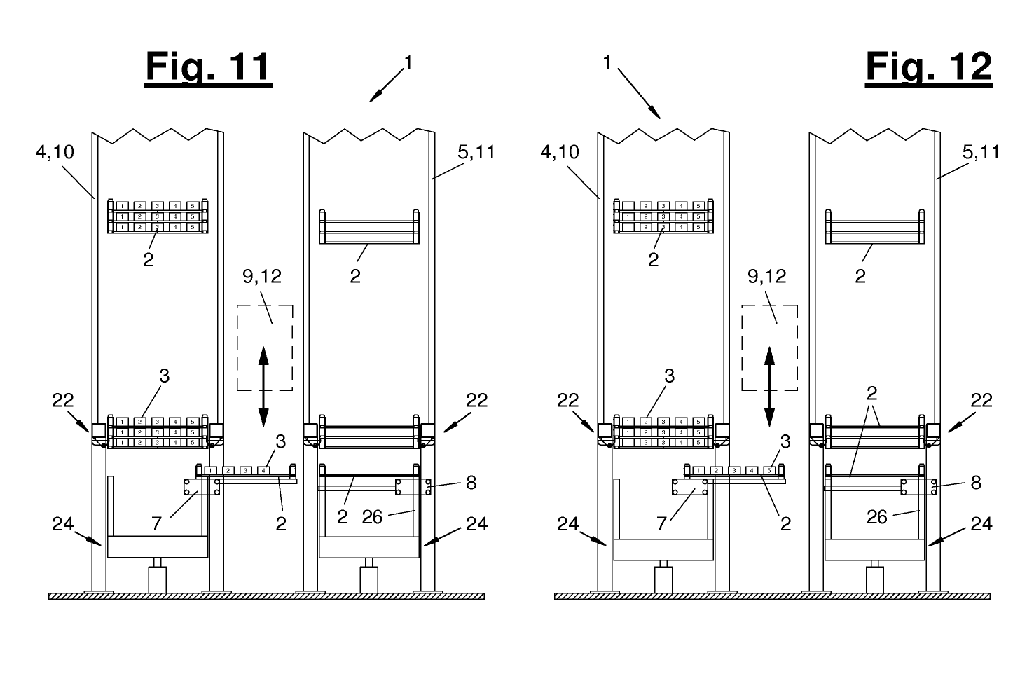

In the next step of FIG. 11, the conveying means (8), standing by [sic, “beretstehende” is a typo for “bereitstehend”—Tr.Ed.], takes over the separated empty goods carrier (2) from the separating and transferring device (24), which has been lowered for this purpose [sic, “Zeck” is a typo for “Zweck”—Tr.Ed.]. The other conveying means (7) is still occupied with the loading activity at the processing device (9) or in the processing zone (12).

In the next step of FIG. 12, the processing device (9) has just placed the last row of goods (3) on the goods carrier (2) held by the conveying means (7), which is now completely filled. The conveying means (8) has taken over the new empty goods carrier (2) and is now moved towards the processing zone (12), whereby the empty goods carrier (2) is positioned directly adjacent to the loaded goods carrier (2).

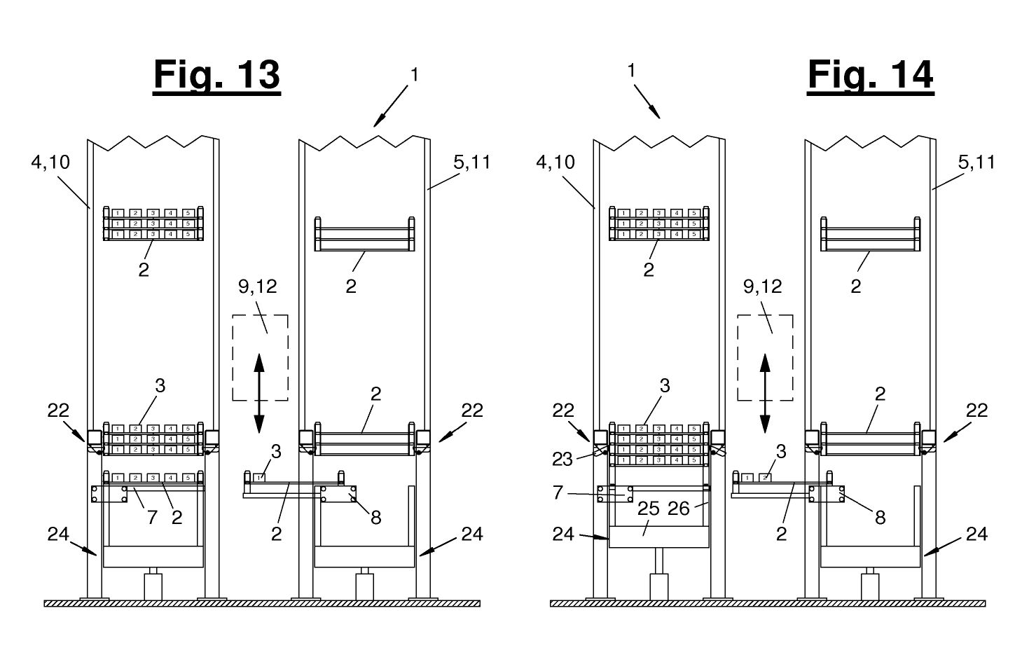

FIG. 13 shows the next step, in which the processing device (9) begins to load the empty goods carrier (2) at the conveying means (8), whereby the conveying means (7) is moved with the full goods carrier (2) in a transfer position at the stacking device (4). Here, the separating and transferring device (24) is positioned in a position suitable for takeover and stands by for receiving the loaded goods carrier (2).

In the next step of FIG. 14, the separating and transferring device (24) takes over the loaded goods carrier (2), lifts it and meshes it with the, at the moment, lowest goods carrier (2) in the stack of carriers. Subsequently, the stack of carriers is lifted and the support device (22) is deactivated. FIG. 14 shows how, due to the upwards movement of the stack of carriers, the stack holders (23) are hereby taken along on their oblique front sides, rotated and unmeshed. In the meantime, the loading process is continued at the other conveying means (8).

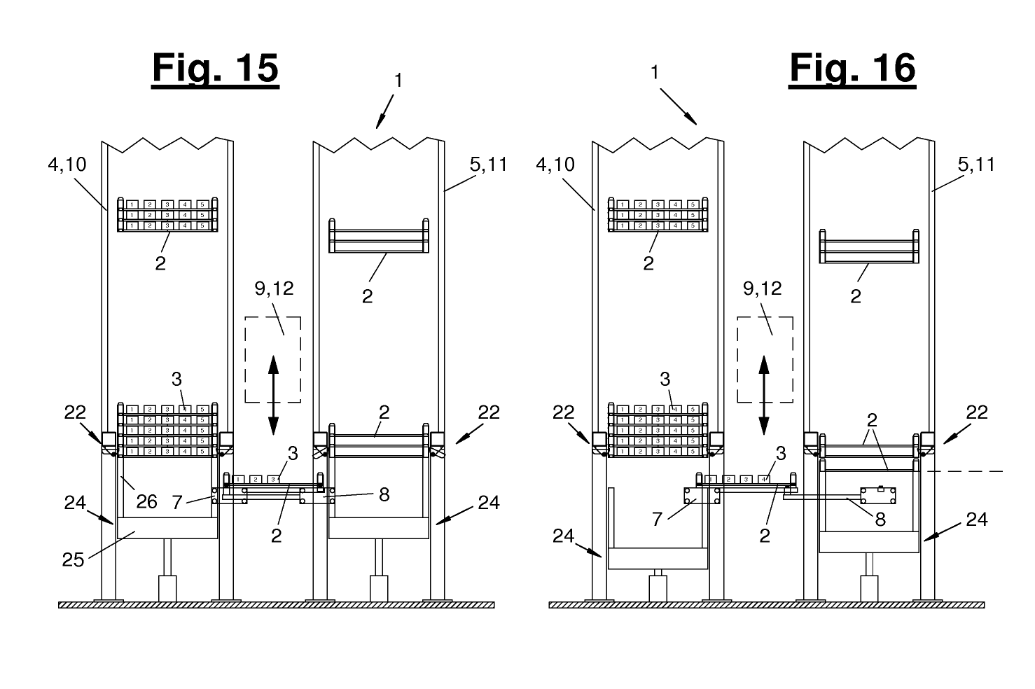

FIG. 15 shows the next step, in which the emptied conveying means (7) is moved back to the processing zone (12) and is brought into an overlapping position with the conveying means (8). In addition, the support device (22) has been activated again at the stacking device (4) and holds onto the stack of carriers. At the other stacking device (5), the separating and transferring device (24) has in the meantime separated and received the next lower goods carrier (2) in the stack.

FIG. 16 shows the next step, in which the conveying means (7) has taken over the partially loaded goods carrier (2) in the manner described above in FIG. 9 and has returned the empty conveying means (8) to the stacking device (5) and the next individual goods carrier (2) held ready there in the intermediate position.

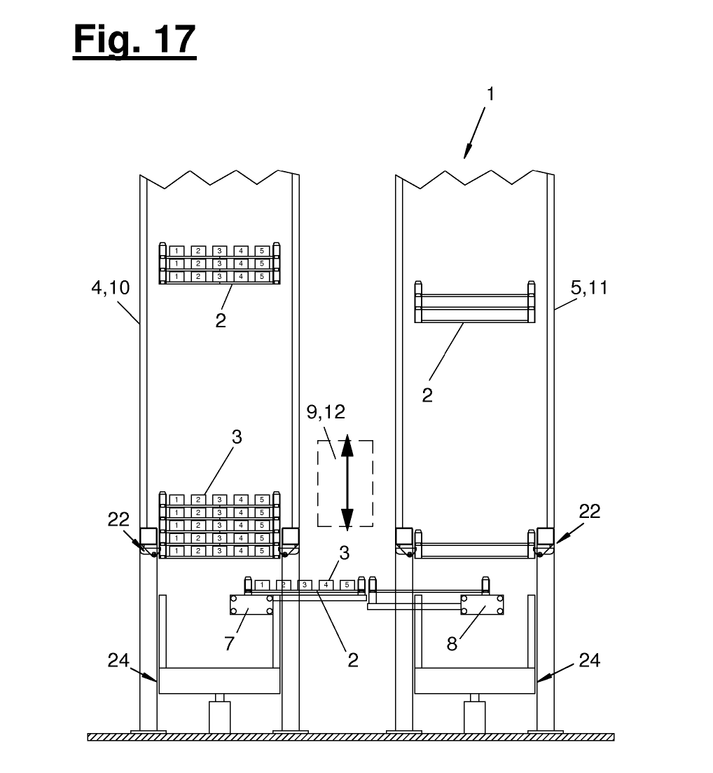

According to the next step of FIG. 17, the conveying means (8) then takes over the empty goods carrier (2) again, whereby here as well the direct connection position at the just completely loaded goods carrier (2) on the conveying means (7) is shown. The above-described cycle then begins anew.

Variants of the above-described mode of operation are possible in a variety of ways. The loading assignment may be reversed, whereby the stacking device (4) on the left side receives empty goods carriers (2) and the stacking device (5) on the right side receives full goods carriers (2). The above-described cycle then runs in a reverse sequence. Such a kinematic reversal takes place, moreover, when, in the exemplary embodiment shown, the goods (3) put into storage and intermediately stored in the stacking and de-stacking device (1) are taken out of storage again. In this case, the conveying means (7) takes over loaded goods carriers (2) from the stacking device (4) or from the separating and transferring device (24) and moves same into the processing zone (12), whereby the goods carrier (2) here is unloaded, e.g., by the processing device (9). During this process, the other conveying means (8) takes over the partially unloaded goods carrier (2) and continues the unloading process, whereby the empty conveying means (7) for the takeover of a next loaded goods carrier (2) returns to the stacking device (4). For its part, the conveying means (8) transfers the emptied goods carrier (2) again to the assigned stacking device (5) in the manner described above.

In the exemplary embodiments shown, the putting into storage and taking out of storage of goods carriers (2) and goods (3) takes place in a reversed sequence in each case. When a first in-first out principle shall be followed, the stacking and de-stacking device (1) may be present in a plurality or it may have one or more additional pairs of stacking devices (4, 5), which are arranged transversely to the plane of the drawing shown in front of or behind the stacking devices (4, 5), whereby a restoring of loaded goods carriers (2) between these pairs takes place in a direction transverse to the plane of the drawing and preferably on the top side of the respective stack of carriers. The stacking sequence of the goods carriers (2) and the goods (3) located therein is turned around hereby. The goods carriers (2) first put into storage at the one pair of devices are then available as the first again at the other pair of devices for taking out of storage and for unloading. An additional conveying device (6) of the kind described above may be available for the other pair of stacking devices (4, 5).

Variants of the exemplary embodiments shown and described are possible in a variety of ways. The structural design of the conveying means (7, 8), their guiding and mounting as well as their drive technique as well as also the design of the carrying means (29, 30) may vary. The mounts (16, 17, 18, 19, 20) arranged at different points of the goods carriers (2) may be varied in their design and arrangement, whereby especially an exchange may also take place.

### LIST OF REFERENCE NUMBERS

1 Stacking and de-stacking device
2 Goods carrier, tray
3 Goods, individually packaged product, can
4 Stacking device for empty goods carrier
5 Stacking device for full goods carrier
6 Conveying device
7 Conveying means, transfer car
8 Conveying means, transfer car
9 Processing device, loading device
10 Stacking zone
11 Stacking zone
12 Processing zone, free space
13 Carrier bottom
14 Carrier frame
15 Support column, support posts
16 Mount for conveying means
17 Mount for conveying means
18 Support point, mount for adjacent posts
19 Support point, mount for stack holder
20 Support point, mount for lifting fingers
21 Frame
22 Support device
23 Stack holder
24 Separating and transferring device
25 Lifting device
26 Lifting fingers
27 Guide, path of motion for conveying means
28 Chassis
29 Carrying means
30 Carrying means
31 Frame part, supporting arm
32 Frame part, supporting arm
33 Carrying element, supporting pin extendable
34 Carrying element, supporting pin extendable
35 Drive

1. Stacking and de-stacking device for goods carrier (2) with a plurality of stacking devices (4, 5), arranged at a distance next to one another, for each receiving and handling at least one stack of goods carriers and a processing zone (12) for goods (3) arranged between same, as well as a conveying device (6), with a conveying means (7, 8) for goods carriers (2), connecting the stacking devices (4, 5) and the processing zone (12), characterized in that the conveying device (6) has a plurality of conveying means (7, 8) which are movable between the stacking devices (4, 5) and the processing zone (12) as well as in relation to one another with paths of motion overlapping one another, whereby the conveying means (7, 8) have carrying means (29, 30), which are designed for the conveying and for the mutual transfer of a goods carrier (2) between the conveying means (7, 8).

2. Stacking and de-stacking device in accordance with claim 1, characterized in that the stacking and de-stacking device (1) has two stacking devices (4, 5), a processing zone (12) and two conveying means (7, 8).

3. Stacking and de-stacking device in accordance with claim 1, characterized in that a processing device (9), in particular a loading device for loading and/or unloading goods (3) on a goods carrier (2) is arranged in the processing zone (12).

4. Stacking and de-stacking device in accordance with claim 1, characterized in that the conveying means (7, 8) are independently movable, especially displaceable, whereby they are movable in a continuous and/or synchronized manner.

5. Stacking and de-stacking device in accordance with claim 1, characterized in that the conveying means (7, 8) have each an independently controllable drive (35).

6. Stacking and de-stacking device in accordance with claim 1, characterized in that the conveying means (7, 8) have each a path of motion extending over the stacking devices (4, 5) and the processing device (9).

7. Stacking and de-stacking device in accordance with claim 1, characterized in that the conveying means (7, 8) are each designed as a transfer car with a common guide (27).

8. Stacking and de-stacking device in accordance with claim 1, characterized in that the conveying means (7, 8) have carrying means (29, 30) that are different and are capable of overlapping one another.

9. Stacking and de-stacking device in accordance with claim 1, characterized in that the conveying means (7, 8) have each movable and controllable, especially vertically adjustable, carrying means (29, 30).

10. Stacking and de-stacking device in accordance with claim 1, characterized in that a carrying means (29, 30) has one or more supporting arms (31, 32) with one or more carrying elements (33, 34) capable of contacting a mount (16, 17) on the goods carrier (2).

11. Stacking and de-stacking device in accordance with claim 1, characterized in that the conveying means (7, 8) have supporting arms (31, 32), which are aligned in the direction of motion of the conveying means (7, 8) and which are directed towards one another and overlap one another.

12. Stacking and de-stacking device in accordance with claim 1, characterized in that a carrying element (33, 34) is designed as a supporting pin, which is movable in a controlled manner, in particular extendable, with a lifting drive.

13. Stacking and de-stacking device in accordance with claim 1, characterized in that the stacking devices (4, 5) have a frame (21) with a support device (22) for a stack of goods carriers (2) and a separating and transferring device (24) for an external, especially lower, goods carrier (2) in the stack.

14. Stacking and de-stacking device in accordance with claim 1, characterized in that the separating and transferring device (24) is designed for the takeover and discharge of individual goods carriers (2) from and to a conveying means (7, 8), whereby the separating and transferring device (24) cooperates with the support device (22).

15. Stacking and de-stacking device in accordance with claim 1, characterized in that the separating and transferring device (24) has a lifting device (25) with a plurality of lifting fingers (26) movable in relation to the conveying means (7, 8).

16. Stacking and de-stacking device in accordance with claim 1, characterized in that the goods carriers (2) are designed as stackable on one another, whereby a goods carrier (2) has a carrier bottom (13) for receiving a plurality of goods (3), preferably arranged in rows.

17. Stacking and de-stacking device in accordance with claim 1, characterized in that a goods carrier (2) has a plurality of differently positioned mounts (16, 17) for the carrying means (29, 30).

18. Stacking and de-stacking device in accordance with claim 1, characterized in that a goods carrier (2) has a plurality of mounts (19, 20) for a support device (22) and a separating and transferring device (24) of a stacking device (4, 5).

19. Method for the stacking and de-stacking of goods carriers (2) between a plurality of stacking zones (10, 11) arranged at a distance next to one another for receiving and handling each at least one stack of goods carriers and a processing zone (12) for goods (3) arranged between same, whereby the goods carriers (2) are conveyed by means of a conveying device (6) with a conveying means (7, 8) connecting the zones (10, 11, 12), characterized in that a goods carrier (2) is conveyed by a plurality of conveying means (7, 8) with carrying means (29, 30) which are moved between the stacking devices (4, 5) and the processing zone (12) as well as in relation to one another with paths of motion overlapping one another, whereby the goods carrier (2) is transferred between the conveying means (7, 8).

20. Method in accordance with claim 19, characterized in that the goods carrier (2) is transferred between the conveying means (7, 8) in the area of the processing zone (12).

21. Method in accordance with claim 19, characterized in that one or more processes are carried out on or with the goods (3) in the processing zone (12) with a processing device (9) there.

22. Method in accordance with claim 19, characterized in that in the processing zone (12) with a processing device (9) there, which is designed as a loading device, goods (3) are reloaded individually or in groups between a conveyor and a goods carrier (2) provided by the conveying device (6).
